(19) United States
(12) Patent Application Publication
(10) Pub. No.: US 2025/0363183 A1
(43) Pub. Date: Nov. 27, 2025

(54) QUANTUM OPTIMIZATION AS A SERVICE

(71) Applicant: SAP SE, Walldorf (DE)

(72) Inventor: Florian Krellner, Altenbamberg (DE)

(21) Appl. No.: 18/671,563

(22) Filed: May 22, 2024

(51) Int. Cl. G06F 17/11

(52) U.S. Cl. CPC G06F 17/11

(57) ABSTRACT

In an example embodiment, various technical challenges are solved using a separate cloud-based optimization service. A code library is distributed to customers to install on their own applications. A customer generates their own optimization model, but the code library takes this optimization model and constructs a unified model based on it. The unified model is then sent to the cloud-based optimization service, which constructs its own version of the model using the unified model. This optimization service-version of the model can then be optimized using one or more solvers that can be shared among many different optimization service-versions of the model, some generated from unified models generated by other customer applications. In that way, the quantum computing resources, as well as traditional computing resources, can be shared among many different customers.

### BACKGROUND

Quantum computing is a type of computing that uses principles of quantum mechanics to perform certain types of calculations much more efficiently than classical computers. Quantum mechanics is a branch of physics that deals with the behavior of very small particles at the quantum level, such as electrons and photons. Unlike classical computers, which use bits as the basic unit of information (0 or 1), quantum computers use quantum bits or qubits.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system, in accordance with an example embodiment.

FIG. 2 is a flow diagram illustrating a method, in accordance with an example embodiment.

FIG. 3 is a block diagram illustrating a software architecture, in accordance with an example embodiment.

FIG. 4 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Quantum computing techniques can be utilized to optimize for various problems. One example of such a problem could be that an organization may wish to minimize the number of trucks needed to deliver parcels, and thus the optimization problem involves finding a feasible allocation of parcels or goods to trucks given that the parcels or goods must be delivered on time.

Some of these optimizations are very difficult to solve, and thus can take an extremely long time, even for a fast classical computer. Quantum computing might offer a mechanism to speed up the solving process.

Technical challenges, however, are encountered when using quantum computing in real-world situations. Specifically, quantum computing solutions often require a customer wishing to perform optimization to create a model that is understandable by one or more solvers, which actually perform the optimization functions. A solver is an algorithm or a set of techniques designed to find solutions to specific computational problems.

There are various types of solvers in quantum computing, each tailored to address different classes of problems. Some common types include:
(1) Quantum Approximate Optimization Algorithm (QAOA): QAOA is a variational algorithm used to solve combinatorial optimization problems. It constructs a parameterized quantum circuit that is optimized to find the minimum energy state corresponding to the solution of the optimization problem.
(2) Variational Quantum Eigensolver (VQE): VQE is used for finding the ground state energy of a given molecule or material. It employs a variational approach, where a parameterized quantum circuit is optimized to minimize the expectation value of the Hamiltonian of the system.
(3) Quantum Phase Estimation (QPE): QPE is a quantum algorithm used for estimating the eigenvalues of a unitary operator. It is often used as a subroutine in other quantum algorithms, such as Shor's algorithm for factoring large numbers and finding the period of a function.
(4) Grover's Algorithm: Grover's algorithm is a quantum search algorithm that can search an unsorted database quadratically faster than classical algorithms. It is useful for searching for a specific item in an unsorted database or finding solutions to certain types of problems.
(5) Quantum Annealing: Quantum Annealing uses a specialized quantum device such as a quantum annealing processorto explore the problem landscape to find the optimal solution. Quantum annealing works by gradually reducing the system's energy towards its ground state, analogous to the process of annealing in metallurgy where a material is heated and then slowly cooled to achieve a desired crystalline structure. In quantum annealing, the quantum system explores potential solutions by transitioning between different quantum states, with the hope that it converges to the global minimum corresponding to the optimal solution of the optimization problem.

Another technical challenge is that quantum solvers can utilize significant hardware resources. The result is that customers who wish to implement quantum computing solutions must obtain and maintain hardware designed to handle such solutions. Indeed, even if a customer wishes to use a mix of traditional and quantum computing, and even if that same customer is only using quantum computing rarely or for a small portion of their optimization problems, they still must maintain hardware that is sufficient to run both the quantum computing optimizations and the traditional computing optimizations at the same time. This creates a high barrier to entry, where many customers feel they cannot utilize quantum computing solutions due to their cost and difficulty in maintaining.

The result of these technical challenges is something called vendor lock-in. That is, a software that can model and solve optimization problem differs in how the optimization problem is implemented. (Normally, one talks about the solver, which solves the optimization problem, and the remaining framework taken as given.) This leads to a vendor lock-in, currently mainly in classical optimization. When solving the optimization problem classically, the optimization problem is defined with a solver, which is vendor-specific modelling software, and solving the problem with another solver is a high investment because the implementation of the model needs to be rewritten. When solving the optimization problem with a quantum computer, the models are implemented for several solvers to experiment with different quantum solvers' quantum hardware. This slows down development and research. There are software packages for modelling independent from the solver that come with other caveats, for example they do not support all features of the solver that is ultimately used, their model creation performance is poor, or they do not support the solver needed, which is the case for quantum solvers.

In an example embodiment, these technical challenges are solved using a separate cloud-based optimization service. A code library is distributed to customers to install on their own applications. A customer generates their own optimization model, but the code library takes this optimization model and constructs a unified model based on it. The unified model is then sent to the cloud-based optimization service, which constructs its own version of the model using the unified model. This optimization service-version of the model can then be optimized using one or more solvers that can be shared among many different optimization service-versions of the model, some generated from unified models generated by other customer applications. In that way, the quantum computing resources, as well as traditional computing resources, can be shared among many different customers.

Assume that there is an optimization problem:

$$Optimize \{ f ( x ) : x ∈ X \}$$

that solves a given problem, such as how to optimally allocate surgeons to operating rooms, or how to optimally allocate freight to trucks. In this notation, ƒ is the objective function that needs to be optimized, either minimized or maximized. The feasible set is X and an x∈X is a feasible action, for example an allocation of pilots to planes. This optimization problem may, in some example embodiments, be automatically generated by transforming the relevant data from an Enterprise Resource Planning (ERP) system and feeding such data and other sources into a model.

For the sake of simplicity, the optimization problem discussed herein is a minimization problem, and thus this disclosure describes, without loss of generality, a minimization problem. This, however, is not intended to be limiting and the described techniques can also be applied to optimization problems other than minimization.

A very common optimization problem is a binary quadratic program, which is defined as follows:

$$minimize \{ {x}^{T} Q x : A x = b , x binary \} .$$

The matrix Q is the cost matrix and the Ax=b defines linear constraints, whereas A is a matrix and b a vector.
The goal is to find a binary vector x that fulfills Ax=b and minimizes the function x [symbol] x^{T}Qx. The optimization problem is without loss of generality a minimization problem.

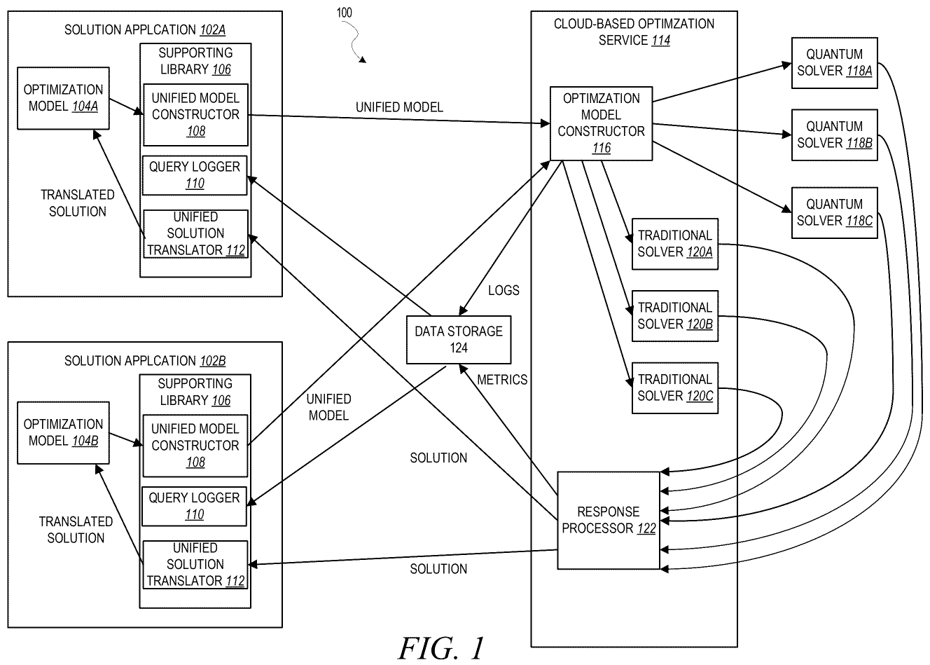

FIG. 1 is a block diagram illustrating a system 100, in accordance with an example embodiment. Solution application 102A may be operated by a first customer and solution application 102B may be operated by a second customer, different than the first customer. The two customers may be unrelated in any way. Each customer may create optimization models in different formats, such that optimization model 104A is in a different format than optimization model 104B. This difference is true even if optimization model 104A is addressing the exact same optimization problem as optimization model 104B. In other words, even if the underlying mathematical representation of the problem and objective of the two models are identical, the optimization model 104A is still in a different format than optimization model 104B by virtue of the customer associated with solution application 102A using a different mechanism to generate the model than the customer associated with solution application 102B.

Each solution application 102A, 102B represents the software used by the corresponding customer to solve some problem. For example, solution application 102A may be for a chain of hardware stores that wants to manage its operations while solution application 102B may be for a hospital network that wants to manage allocation of surgical resources.

The optimization models 104A, 104B are mathematical optimization models created based on available data. These models 104A, 104B are implemented by software developers who develop the corresponding solution application 102A, 102B. These models 104A, 104B may also be considered to be “third-party models” to distinguish them from models created for more general use, such as the unified model described later.

A supporting library 106 may be distributed to the solution applications, and specifically to solution application 102A and solution application 102B. The supporting library 106 is a library of different software code procedures that act to perform specific functions used to accomplish the present solution. Here, this includes a unified model constructor 108, a query logger 110, and a unified solution translator 112.

The unified model constructor 108 takes an optimization model, such as optimization model 104A or optimization model 104B, which were developed in a format that may not be usable by other components or applications, and constructs a unified model from it. The unified model is one that will be usable by the cloud-based optimization service 114. This unified model may be sent to an optimization model constructor 116 via, for example, an Application Program Interface (API).

The unified model constructor 108 may construct the unified model by performing a series of operations. First, variables can be extracted from the third-party model (e.g., optimization model 104A or optimization model 104B). Then constraints may be extracted from the third-party model. These constraints may be represented by two lists—one that includes variable names and one that includes coefficients to be applied to those variable names. The constraints also may have operators (e.g., +, −, <, etc.) that are obtained through this operation. Then an objective is extracted from the third-party model. This objective may be represented as a coefficient to be applied to one or two variables.

In an example embodiment, the unified model is stored as a JavaScript Object Notation (JSON) file. JSON is a in lightweight data-interchange format. The following is an example of a unified optimization model represented as a JSON:

```
{
  “objective”: {
    “type”: “maximize”,
    “expression”: “3*x + 2*y”
  },
  “constraints”: [
    {
      “expression”: “x + y <= 10”,
      “name”: “constraint1”:
    },
    {
      “expression”: “2*x − y >= 5”,
      “name”: “constraint2”
    }
  ],
  “variables”: [
    {
      “name”: “x”,
      “type”: “continuous”,
      “bounds”: [0, 10]
    },
    {
      “name”: “y”,
      “type”: “continuous”,
      “bounds”: [0, 20]
    }
  ]
}
```

objective: This object represents the optimization objective. It has two fields; “type” specifies whether it's a maximization or minimization problem, and “expression” represents the mathematical expression of the objective function.
constraints: This is an array of constraint objects. Each constraint object has two fields:
   expression: Represents the mathematical expression of the constraint.
   name: Optional field to provide a name or identifier for the constraint.
variables: This is an array of variable objects. Each variable object has three fields:
   name: Represents the name of the variable.
   type: Specifies the type of the variable (continuous, integer, binary, etc.).
   bounds: Represents the lower and upper bounds of the variable.

The optimization model constructor 116 receives the unified model(s) from the solution application(s) 102A, 102B and constructs its own optimization model(s) from the unified model(s). The optimization model(s) constructed by the optimization model constructor 116 may or may not be of an identical type to any of the third-party optimization model(s) 104A, 104B. This operation is performed so as to have the model represented in a type that is understandable by one or more quantum solvers 118A, 118B, 118C, and traditional solvers 120A, 120B, 120C.

Also as part of this optimization model construction, the specific solvers 118A, 118B, 118C, 120A, 120B, 120C to be utilized to obtain a solution are selected. These solvers may be selected from quantum solvers, such as quantum solver 118A, 118B, or 118C, from traditional solvers, such as traditional solvers 120A, 120B, 120C, or any combination of both. Here, quantum solvers 118A, 118B, 118C are depicted as being located separate from the cloud-based optimization service 114 while traditional solvers 120A, 120B, 120C are depicted as being located at the cloud-based optimization service 114. This, however, is not mandatory, although in many circumstances will be accurate, as quantum solvers 118A, 118B, 118C often utilize significant computing resources that would not be available on the cloud-based optimization service 114 itself. In some instances both the traditional solvers 120A, 120B, 120C and the quantum solvers 118A, 118B, 118C are located separate from the cloud-based optimization service 114, although in many cases this may not be desirable as it requires the calling of separate optimization services.

Once the specific combination of solvers 118A, 118B, 118C, 120A, 120B, 120C is selected, the optimization model is passed from the optimization model constructor 116 to the specific combination of solvers 118A, 118B, 118C, 120A, 120B, 120C to actually solve the model. Solutions are then passed to the response processor 122. These solutions may be in the same format as the optimization model that was passed to the specific combination of solvers 118A, 118B, 118C, 120A, 120B, 120C. As such, the response processor 122 creates a unified solution representation.

Notably, the solvers 118A, 118B, 118C, 120A, 120B, 120C may each be utilized by any or all of the solution applications 102A, 102B. This allows the resources utilized by the solvers 118A, 118B, 118C, 120A, 120B, 120C to be shared, eliminating waste in computing resources. This can be especially important for quantum solvers 118A, 118B, 118C, which use significant hardware resources and yet may be rarely used if not shared among multiple solution applications 102A, 102B.

The unified solution representation is then passed back to the particular solution application 102A, 102B that sent the unified model, and specifically to a unified solution translator 112 in the supporting library 106. The unified solution translator 112 then transforms the unified solution into a problem-specific data structure corresponding to the original problem of the particular optimization model 104A, 104B.

It should be noted that both the unified solution translator 112 and the unified model constructor 108 may utilize a stored mapping (not pictured) of variables and possible values of each type of optimization model 104A, 104B. The mapping may be used by the unified model constructor 108 in converting the optimization model 104A, 104B into a unified model, and may be used by the unified solution translator 112 in determining how to construct or populate the data structure to report the solution.

A data storage 124 may then be used to store logs and metrics of the optimization process. Specifically, optimization model constructor 116 may communicate logs of which unified models were converted to which optimization models and which solvers were invoked to produce solutions. The response processor 122 may communicate metrics of those solutions, including, for example, how quickly the solutions were calculated by each of the invoked solvers.

It should be noted that the meaning of “optimal” or “optimized” can vary based upon the needs of the designer or administrator, and thus the terms in this context shall not be interpreted to be limited to an absolute “best” solution. For example, while one administrator may indeed be looking for the absolute “best” solution, another may be looking for simply the best solution that can be found that is within 5% of some desired endpoint, or the best solution that can be found after a fixed number of iterations. In other words, “optimal” or “optimized” does not necessarily mean “best” but instead means “good enough,” based on criteria set up by someone in charge of the system.

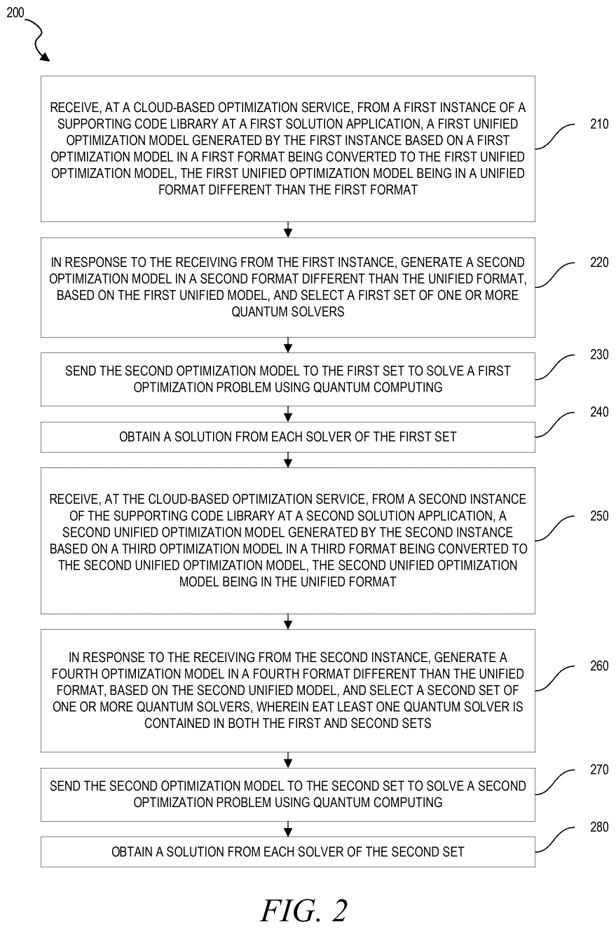

FIG. 2 is a flow diagram illustrating a method 200, in accordance with an example embodiment.

At operation 210, a first unified optimization model generated by the first instance based on a first optimization model in a first format being converted to the first unified optimization model is received, at a cloud-based optimization service, from a first instance of a supporting code library at a first solution application. The first unified optimization model is in a unified format different than the first format.

At operation 220, in response to the receiving from the first instance, a second optimization model is generated in a second format different than the unified format, based on the first unified model, and a first set of one or more quantum solvers is selected. At operation 230, the second optimization model is sent to the first set to solve a first optimization problem using quantum computing. At operation 240, a solution is obtained from each solver of the first set.

At operation 250, a second unified optimization model generated by the second instance based on a third optimization model in a third format being converted to the second unified optimization model is received, at the cloud-based optimization service, from a second instance of the supporting code library at a second solution application. The second unified optimization model is in the unified format.

At operation 260, in response to the receiving from the second instance, a fourth optimization model is generated in a fourth format different than the unified format, based on the second unified model, and a second set of one or more quantum solvers is selected, wherein at least one quantum solver is contained in both the first and second sets.

At operation 270, the second optimization model is sent to the second set to solve a second optimization problem using quantum computing.

At operation 280, a solution is obtained from each solver of the second set.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1 is a system comprising: at least one hardware processor; and a computer-readable medium storing instructions that, when executed by the at least one hardware processor, cause the at least one hardware processor to perform operations comprising: receiving, at a cloud-based optimization service, from a first instance of a supporting code library at a first solution application, a first unified optimization model generated by the first instance based on a first optimization model in a first format being converted to the first unified optimization model, the first unified optimization model being in a unified format different than the first format; in response to the receiving from the first instance, generating a second optimization model in a second format different than the unified format, based on the first unified model, and selecting a first set of one or more quantum solvers; sending the second optimization model to the first set to solve a first optimization problem using quantum computing; obtaining a solution from each solver of the first set; receiving, at the cloud-based optimization service, from a second instance of the supporting code library at a second solution application, a second unified optimization model generated by the second instance based on a third optimization model in a third format being converted to the second unified optimization model, the second unified optimization model being in the unified format; in response to the receiving from the second instance, generating a fourth optimization model in a fourth format different than the unified format, based on the second unified model, and selecting a second set of one or more quantum solvers, wherein at least one quantum solver is contained in both the first and second sets; sending the second optimization model to the second set to solve a second optimization problem using quantum computing; and obtaining a solution from each solver of the second set.

In Example 2, the subject matter of Example 1 includes, wherein the selecting a first set further includes selecting a third set of non-quantum solvers, and wherein the second optimization model further includes sending the second optimization model to the third set.

In Example 3, the subject matter of Examples 1-2 includes, wherein the first format is identical to the second format.

In Example 4, the subject matter of Examples 1-3 includes, wherein the first unified optimization model is stored as a JavaScript Object Notation (JSON) file.

In Example 5, the subject matter of Examples 1-4 includes, wherein the operations further comprise: generating a unified format version of the solution from each solver of the first set; and communicating the unified format version of the solution from each solver of the first set to the first solution application.

In Example 6, the subject matter of Example 5 includes, wherein the generating is performed using a mapping of variables and possible values.

In Example 7, the subject matter of Examples 1-6 includes, wherein the operations further comprise: storing, in a storage device, logs of communications between the cloud-based optimization service and the first and second sets of one or more quantum solvers and metrics regarding calculating optimized solutions by the first and second sets of one or more quantum solvers in a data storage for access by either the first solution application or the second solution application.

In Example 8, the subject matter of Example 7 includes, wherein the metrics include a speed of solving the first optimization model and a speed of solving the second optimization model.

In Example 9, the subject matter of Examples 7-8 includes, wherein the supporting code library includes a query logger capable of querying the stored logs in the storage device.

In Example 10, the subject matter of Examples 1-9 includes, wherein the operations further comprise: converting the solution from each solver in the first set into the unified format; and sending the converted solution from each solver in the first set to the first instance of a supporting code library.

In Example 11, the subject matter of Examples 6-10 includes, wherein the operations further comprise: converting the solution from each solver in the first set into the unified format, wherein the converting is performed using the mapping; and sending the converted solution from each solver in the first set to the first instance of a supporting code library.

Example 12 is a method comprising: receiving, at a cloud-based optimization service, from a first instance of a supporting code library at a first solution application, a first unified optimization model generated by the first instance based on a first optimization model in a first format being converted to the first unified optimization model, the first unified optimization model being in a unified format different than the first format; in response to the receiving from the first instance, generating a second optimization model in a second format different than the unified format, based on the first unified model, and selecting a first set of one or more quantum solvers; sending the second optimization model to the first set to solve a first optimization problem using quantum computing; obtaining a solution from each solver of the first set; receiving, at the cloud-based optimization service, from a second instance of the supporting code library at a second solution application, a second unified optimization model generated by the second instance based on a third optimization model in a third format being converted to the second unified optimization model, the second unified optimization model being in the unified format; in response to the receiving from the second instance, generating a fourth optimization model in a fourth format different than the unified format, based on the second unified model, and selecting a second set of one or more quantum solvers, wherein at least one quantum solver is contained in both the first and second sets; sending the second optimization model to the second set to solve a second optimization problem using quantum computing; and obtaining a solution from each solver of the second set.

In Example 13, the subject matter of Example 12 includes, wherein the selecting a first set further includes selecting a third set of non-quantum solvers, and wherein the second optimization model further includes sending the second optimization model to the third set.

In Example 14, the subject matter of Examples 12-13 includes, wherein the first format is identical to the second format.

In Example 15, the subject matter of Examples 12-14 includes, wherein the first unified optimization model is stored as a JavaScript Object Notation (JSON) file.

In Example 16, the subject matter of Examples 12-15 includes, generating a unified format version of the solution from each solver of the first set; and communicating the unified format version of the solution from each solver of the first set to the first solution application.

In Example 17, the subject matter of Example 16 includes, wherein the generating is performed using a mapping of variables and possible values.

In Example 18, the subject matter of Examples 12-17 includes, storing logs of communications between the cloud-based optimization service and the first and second sets of one or more quantum solvers and metrics regarding calculating optimized solutions by the first and second sets of one or more quantum solvers in a data storage for access by either the first solution application or the second solution application.

Example 19 is a non-transitory machine-readable medium storing instructions which, when executed by one or more processors, cause the one or more processors to perform operations comprising: receiving, at a cloud-based optimization service, from a first instance of a supporting code library at a first solution application, a first unified optimization model generated by the first instance based on a first optimization model in a first format being converted to the first unified optimization model, the first unified optimization model being in a unified format different than the first format; in response to the receiving from the first instance, generating a second optimization model in a second format different than the unified format, based on the first unified model, and selecting a first set of one or more quantum solvers; sending the second optimization model to the first set to solve a first optimization problem using quantum computing; obtaining a solution from each solver of the first set; receiving, at the cloud-based optimization service, from a second instance of the supporting code library at a second solution application, a second unified optimization model generated by the second instance based on a third optimization model in a third format being converted to the second unified optimization model, the second unified optimization model being in the unified format; in response to the receiving from the second instance, generating a fourth optimization model in a fourth format different than the unified format, based on the second unified model, and selecting a second set of one or more quantum solvers, wherein at least one quantum solver is contained in both the first and second sets; sending the second optimization model to the second set to solve a second optimization problem using quantum computing; and obtaining a solution from each solver of the second set.

In Example 20, the subject matter of Example 19 includes, wherein the selecting a first set further includes selecting a third set of non-quantum solvers, and wherein the second optimization model further includes sending the second optimization model to the third set.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

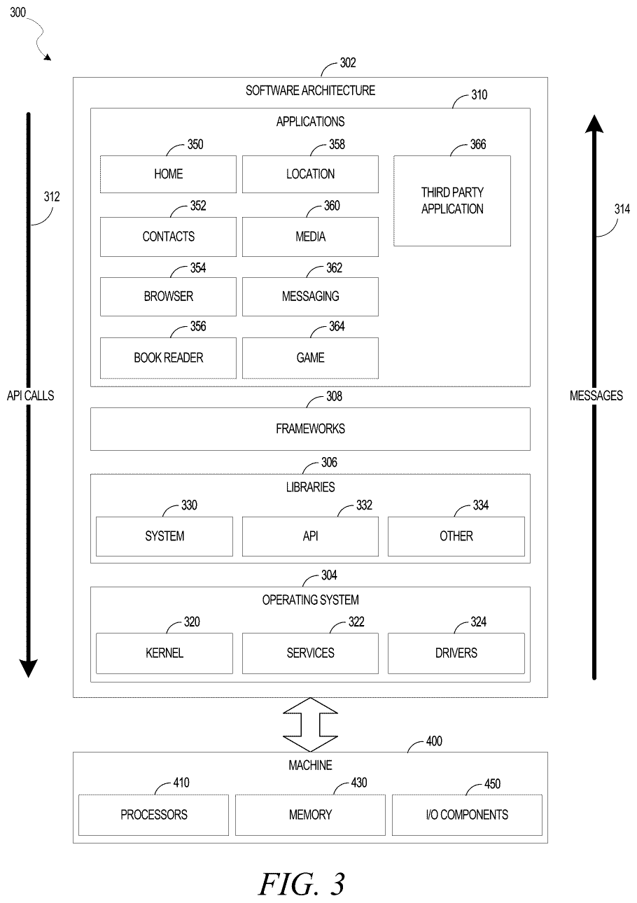

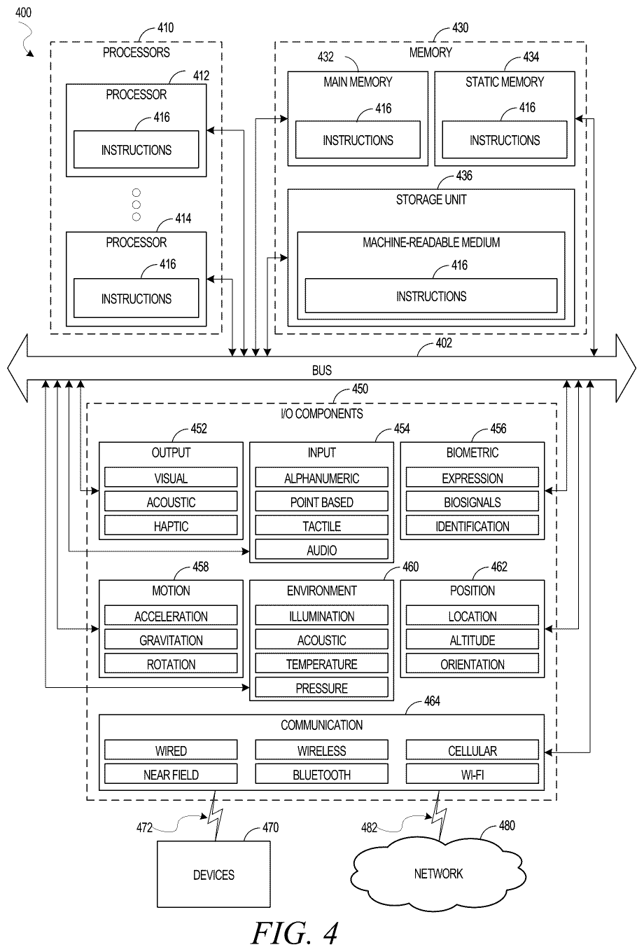

FIG. 3 is a block diagram 300 illustrating a software architecture 302, which can be installed on any one or more of the devices described above. FIG. 3 is merely a non-limiting example of a software architecture, and it will be appreciated that many other architectures can be implemented to facilitate the functionality described herein. In various embodiments, the software architecture 302 is implemented by hardware such as a machine 400 of FIG. 4 that includes processors 410, memory 430, and input/output (I/O) components 450. In this example architecture, the software architecture 302 can be conceptualized as a stack of layers where each layer may provide a particular functionality. For example, the software architecture 302 includes layers such as an operating system 304, libraries 306, frameworks 308, and applications 310. Operationally, the applications 310 invoke API calls 312 through the software stack and receive messages 314 in response to the API calls 312, consistent with some embodiments.

In various implementations, the operating system 304 manages hardware resources and provides common services. The operating system 304 includes, for example, a kernel 320, services 322, and drivers 324. The kernel 320 acts as an abstraction layer between the hardware and the other software layers, consistent with some embodiments. For example, the kernel 320 provides memory management, processor management (e.g., scheduling), component management, networking, and security settings, among other functionality. The services 322 can provide other common services for the other software layers. The drivers 324 are responsible for controlling or interfacing with the underlying hardware. For instance, the drivers 324 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 306 provide a low-level common infrastructure utilized by the applications 310. The libraries 306 can include system libraries 330 (e.g., C standard library) that can provide functions such as memory allocation functions, string manipulation functions, mathematic functions, and the like. In addition, the libraries 306 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (PEG or JPG), or Portable Network Graphics (PNG), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 306 can also include a wide variety of other libraries 334 to provide many other APIs to the applications 310.

The frameworks 308 provide a high-level common infrastructure that can be utilized by the applications 310. For example, the frameworks 308 provide various graphical user interface functions, high-level resource management, high-level location services, and so forth. The frameworks 308 can provide a broad spectrum of other APIs that can be utilized by the applications 310, some of which may be specific to a particular operating system 304 or platform.

In an example embodiment, the applications 310 include a home application 350, a contacts application 352, a browser application 354, a book reader application 356, a location application 358, a media application 360, a messaging application 362, a game application 364, and a broad assortment of other applications, such as a third-party application 366. The applications 310 are programs that execute functions defined in the programs. Various programming languages can be employed to create one or more of the applications 310, structured in a variety of manners, such as object-oriented programming languages (e.g., Objective-C, Java, or C++) or procedural programming languages (e.g., C or assembly language). In a specific example, the third-party application 366 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 366 can invoke the API calls 312 provided by the operating system 304 to facilitate functionality described herein.

FIG. 4 illustrates a diagrammatic representation of a machine 400 in the form of a computer system within which a set of instructions may be executed for causing the machine 400 to perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed. For example, the instructions 416 may cause the machine 400 to execute the method of FIG. 2. Additionally, or alternatively, the instructions 416 may implement FIGS. 1-3 and so forth. The instructions 416 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer [or distributed] network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device [e.g., a smart watch], a smart home device [e.g., a smart appliance], other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 may include processors 410, memory 430, and I/O components 450, which may be configured to communicate with each other such as via a bus 402. In an example embodiment, the processors 410 (e.g., a central processing unit (CPU), a reduced instruction set computing (RISC) processor, a complex instruction set computing (CISC) processor, a graphics processing unit (GPU), a digital signal processor D (SP), an application-specific integrated circuit (ASIC), a radio-frequency integrated circuit (RFIC), another processor, or any suitable combination thereof) may include, for example, a processor 412 and a processor 414 that may execute the instructions 416. The term “processor” is intended to include multi-core processors that may comprise two or more independent processors (sometimes referred to as “cores”) that may execute instructions 416 contemporaneously. Although FIG. 4 shows multiple processors 410, the machine 400 may include a single processor 412 with a single core, a single processor 412 with multiple cores (e.g., a multi-core processor 412), multiple processors 412, 414 with a single core, multiple processors 412, 414 with multiple cores, or any combination thereof.

The memory 430 may include a main memory 432, a static memory 434, and a storage unit 436, each accessible to the processors 410 such as via the bus 402. The main memory 432, the static memory 434, and the storage unit 436 store the instructions 416 embodying any one or more of the methodologies or functions described herein. The instructions 416 may also reside, completely or partially, within the main memory 432, within the static memory 434, within the storage unit 436, within at least one of the processors 410 (e.g., within the processor's cache memory), or any suitable combination thereof, during execution thereof by the machine 400.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion, and the grouping is in no way limiting. In various example embodiments, the I/O components 450 may include output components 452 and input components 454. The output components 452 may include visual components (e.g., a display such as a plasma display panel [PDP], a light-emitting diode (LED) display, a liquid crystal display (LCD), a projector, or a cathode ray tube (CRT), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 450 may include biometric components 456, motion components 458, environmental components 460, or position components 462, among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 462 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication components 464 operable to couple the machine 400 to a network 480 or devices 470 via a coupling 482 and a coupling 472, respectively. For example, the communication components 464 may include a network interface component or another suitable device to interface with the network 480. In further examples, the communication components 464 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., coupled via a USB).

Moreover, the communication components 464 may detect identifiers or include components operable to detect identifiers. For example, the communication components 464 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as location via Internet Protocol (IP) geolocation, location via Wi-Fi® signal triangulation, location via detecting an NFC beacon signal that may indicate a particular location, and so forth.

The various memories (i.e., 430, 432, 434, and/or memory of the processor(s) 410) and/or the storage unit 436 may store one or more sets of instructions 416 and data structures (e.g., software) embodying or utilized by any one or more of the methodologies or functions described herein. These instructions (e.g., the instructions 416), when executed by the processor(s) 410, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 480 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network, and the coupling 482 may be a Code Division Multiple Access (CDMA) connection, a Global System for Mobile communications (GSM) connection, or another type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., Hypertext Transfer Protocol (HTTP)). Similarly, the instructions 416 may be transmitted or received using a transmission medium via the coupling 472 (e.g., a peer-to-peer coupling) to the devices 470. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 416 for execution by the machine 400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, from a first instance of a supporting code library at a first solution application, a first unified optimization model generated by the first instance based on a first optimization model in a first format being converted to the first unified optimization model, the first unified optimization model being in a unified format different than the first format;
in response to the receiving from the first instance, generating a second optimization model in a second format, based on the first unified model, and selecting a first set of one or more quantum solvers;
sending the second optimization model to the first set to solve a first optimization problem using quantum computing;
obtaining a solution from each solver of the first set;
receiving, at the cloud-based optimization service, from a second instance of the supporting code library at a second solution application, a second unified optimization model generated by the second instance based on a third optimization model in a third format, the second unified optimization model being in the unified format;
in response to the receiving from the second instance, generating a fourth optimization model in a fourth format different than the unified format, based on the second unified model, and selecting a second set of one or more quantum solvers, wherein at least one quantum solver is contained in both the first and second sets;
sending the second optimization model to the second set; and
obtaining a solution from each solver of the second set.

2. The system of claim 1, wherein the selecting a first set further includes selecting a third set of non-quantum solvers, and wherein the second optimization model further includes sending the second optimization model to the third set.

3. The system of claim 1, wherein the first format is identical to the second format.

4. The system of claim 1, wherein the first unified optimization model is stored as a JavaScript Object Notation (JSON) file.

5. The system of claim 1, wherein the operations further comprise:
generating a unified format version of the solution from each solver of the first set; and
communicating the unified format version of the solution from each solver of the first set to the first solution application.

6. The system of claim 5, wherein the generating is performed using a mapping of variables and possible values.

7. The system of claim 1, wherein the operations further comprise:
storing, in a storage device, logs of communications between the cloud-based optimization service and the first and second sets of one or more quantum solvers and metrics regarding calculating optimized solutions by the first and second sets of one or more quantum solvers in a data storage for access by either the first solution application or the second solution application.

8. The system of claim 7, wherein the metrics include a speed of solving the first optimization model and a speed of solving the second optimization model.

9. The system of claim 7, wherein the supporting code library includes a query logger capable of querying the stored logs in the storage device.

10. The system of claim 1, wherein the operations further comprise:
converting the solution from each solver in the first set into the unified format; and
sending the converted solution from each solver in the first set to the first instance of a supporting code library.

11. The system of claim 6, wherein the operations further comprise:
converting the solution from each solver in the first set into the unified format, wherein the converting is performed using the mapping; and
sending the converted solution from each solver in the first set to the first instance of a supporting code library.

12. A method comprising:
receiving, from a first instance of a supporting code library at a first solution application, a first unified optimization model generated by the first instance based on a first optimization model in a first format being converted to the first unified optimization model, the first unified optimization model being in a unified format different than the first format;
in response to the receiving from the first instance, generating a second optimization model in a second format, based on the first unified model, and selecting a first set of one or more quantum solvers;
sending the second optimization model to the first set to solve a first optimization problem using quantum computing;
obtaining a solution from each solver of the first set;
receiving, at the cloud-based optimization service, from a second instance of the supporting code library at a second solution application, a second unified optimization model generated by the second instance based on a third optimization model in a third format, the second unified optimization model being in the unified format;
in response to the receiving from the second instance, generating a fourth optimization model in a fourth format different than the unified format, based on the second unified model, and selecting a second set of one or more quantum solvers, wherein at least one quantum solver is contained in both the first and second sets;
sending the second optimization model to the second set; and
obtaining a solution from each solver of the second set.

13. The method of claim 12, wherein the selecting a first set further includes selecting a third set of non-quantum solvers, and wherein the second optimization model further includes sending the second optimization model to the third set.

14. The method of claim 12, wherein the first format is identical to the second format.

15. The method of claim 12, wherein the first unified optimization model is stored as a JavaScript Object Notation (JSON) file.

16. The method of claim 12, further comprising:
generating a unified format version of the solution from each solver of the first set; and
communicating the unified format version of the solution from each solver of the first set to the first solution application.

17. The method of claim 16, wherein the generating is performed using a mapping of variables and possible values.

18. The method of claim 12, further comprising:
storing logs of communications between the cloud-based optimization service and the first and second sets of one or more quantum solvers and metrics regarding calculating optimized solutions by the first and second sets of one or more quantum solvers in a data storage for access by either the first solution application or the second solution application.

19. A non-transitory machine-readable medium storing instructions which, when executed by one or more processors, cause the one or more processors to perform operations comprising:
receiving, from a first instance of a supporting code library at a first solution application, a first unified optimization model generated by the first instance based on a first optimization model in a first format being converted to the first unified optimization model, the first unified optimization model being in a unified format different than the first format;
in response to the receiving from the first instance, generating a second optimization model in a second format, based on the first unified model, and selecting a first set of one or more quantum solvers;
sending the second optimization model to the first set to solve a first optimization problem using quantum computing;
obtaining a solution from each solver of the first set;
receiving, at the cloud-based optimization service, from a second instance of the supporting code library at a second solution application, a second unified optimization model generated by the second instance based on a third optimization model in a third format, the second unified optimization model being in the unified format;
in response to the receiving from the second instance, generating a fourth optimization model in a fourth format different than the unified format, based on the second unified model, and selecting a second set of one or more quantum solvers, wherein at least one quantum solver is contained in both the first and second sets;
sending the second optimization model to the second set; and
obtaining a solution from each solver of the second set.

20. The non-transitory machine-readable medium of claim 19, wherein the selecting a first set further includes selecting a third set of non-quantum solvers, and wherein the second optimization model further includes sending the second optimization model to the third set.
